(19) United States
(12) Patent Application Publication
(10) Pub. No.: US 2017/0240776 A1
(43) Pub. Date: Aug. 24, 2017

(54) WET AND DRY SURFACE ADHESIVES

(71) Applicant: 3M INNOVATIVE PROPERTIES COMPANY, St. Paul, MN (US)

(72) Inventors: Gregg A. Patnode, Woodbury, MN (US); Michael P. Daniels, Inver Grover Heights, MN (US)

(21) Appl. No.: 15/301,921

(22) PCT Filed: Apr. 3, 2015
(86) PCT No.: PCT/US15/24270

§ 371 Date: Oct. 4, 2016

Related U.S. Application Data
(60) Provisional application No. 61/975,491, filed on Apr. 4, 2014.

(51) Int. Cl. C09J 7/02; C09J 11/08

(52) U.S. Cl. CPC C09J 7/0217; C09J 11/08; C09J 2400/163; C09J 2495/006; C09J 133/08

(57) ABSTRACT

A pressure sensitive adhesive comprising the polymerization product of: (a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.; (b) about 70 to about 30 parts by weight of one or more hydrophilic acidic comonomers wherein the hydrophilic acidic monomers, when polymerized in the absence of other comonomers, yield a polymer or copolymer having a T_{g} of less than about 40° C.; and (c) about 10 to about 70 parts based on 100 parts of the sum of components (a)+(b) of a non-reactive plasticizing agent, wherein the pressure sensitive adhesive adheres quickly to wet or dry substrate surfaces; and a method of making.

### FIELD OF THE INVENTION

This invention pertains to pressure-sensitive adhesives, and more particularly to plasticizer-loaded pressure-sensitive adhesives, which provide all of the three properties quick stick, high tack, and strong adhesion to both wet and dry surfaces.

### BACKGROUND OF INVENTION

Pressure sensitive adhesives that adhere to wet or moist surfaces, so-called “wet-stick” adhesives, are useful in selected industrial, commercial and consumer applications. In pharmaceutical and other medical fields, such wet-stick adhesives are typically used for adhering articles such as tapes, bandages, dressings, and drapes to moist skin surfaces such as wounds or areas of the body prone to moistness. Wet-stick adhesives also find use in outdoor or exterior applications, such as on roadway materials, such as pavement surfaces such as asphalt pavement, and in pavement marking tapes, traffic control signage, and marine or automotive coatings and surfaces. Labels for food containers and other products that are exposed to moisture due to condensation or subjected to water or ice immersion also must be coated with wet-stick adhesives.

(Meth)acrylate pressure sensitive adhesives are attractive materials for many tape and label applications. (Meth)acrylates are known for their optical clarity, oxidative resistance, and inherently tacky nature. Inherently tacky (meth)acrylate pressure sensitive adhesives (i.e., materials that require no additives such as tackifying resins) are typically formulated predominately from acrylic acid ester monomers of non-tertiary alcohols. Examples of such monomers include n-butyl acrylate, 2-ethylhexyl acrylate, isooctyl acrylate, isononyl acrylate, isodecyl acrylate and dodecyl acrylate. When these (meth)acrylate monomers are polymerized, the homopolymers have a glass transition temperature (T_{g}) of less than about 0° C. This low T_{g} is a necessary property in (meth)acrylate materials that exhibit tack at room temperature. Such (meth)acrylate polymers are hydrophobic in nature and, without modification, are generally unsuitable as wet-stick adhesives.

A means to render (meth)acrylate polymers more hydrophilic is to copolymerize the (meth)acrylate monomers with hydrophilic acidic comonomers, such as acrylic acid, methacrylic acid, beta-carboxyethyl acrylate, itaconic acid, sulfoethyl acrylate and the like. Addition of these hydrophilic acidic comonomers in minor amounts (e.g., about 1 to about 15 wt %) can also enhance the internal or cohesive strength of the PSA. This increased polymer reinforcement, however, can diminish the tack of the hydrophilic acidic comonomer-containing (meth)acrylate copolymer.

At higher acidic comonomer levels, (meth)acrylate copolymers can dramatically lose their tack and become highly hydrophilic. When exposed to water, the moisture helps to transform these highly acidic, low tack compositions into tacky materials that are suitable as wet-stick adhesives used in many medical applications. When the water evaporates, these adhesives lose their pressure-sensitive tack. Such compositions can also be useful as water-soluble or water dispersible adhesives. Water-dispersible or soluble (meth)acrylate copolymers can be formulated as repulpable adhesives used to splice dry paper rolls and designed to lose adhesive integrity and fully degrade when undergoing paper recycling operations.

U.S. Pat. No. 6,855,386 (Daniels et al.) discloses wet stick adhesives comprising the reaction product of (meth)acrylate copolymers, hydrophilic acidic comonomer, and plasticizing agent.

When producing wet stick adhesives based on (meth)acrylate copolymers having high levels of acidic comonomers, it is necessary to provide high levels of hydrophilic plasticizer to overcome the glassy nature of the adhesive. To provide an adhesive that can create a bond in the presence of moisture, water must be absorbed into the polymer system to allow adhesive softening, thus allowing the formation of a bond to the wet surface. While such systems will produce a bond in the presence of surface moisture, they have the disadvantage of being low tack systems that take time for the bond to form in the presence of water. Thus, the time required for such adhesives to bond in the presence of water is of a greater magnitude that the time required to apply the adhesives. In addition, these systems do not make strong or quick bonds in the absence of moisture.

There exists a need for an adhesive system that can make a quick stick, high tack initial bond and strong adhesion long term bond to both wet and dry surfaces.

### SUMMARY OF INVENTION

The present invention provides novel pressure sensitive adhesive compositions that provide surprising performance, articles comprising such adhesive formulations, and methods for making such adhesive formulations. Like the adhesive compositions disclosed in U.S. Pat. No. 6,855,386 (Daniels et al.), the adhesive compositions of the invention comprise the reaction product of (meth)acrylate comonomers, hydrophilic acidic monomers, and non-reactive plasticizing agent. It has been surprisingly discovered that if: (1) the hydrophilic acidic monomers are selected such that, if polymerized in the absence of other comonomers, yield a polymer or copolymer having a T_{g} of less than about 40° C., and (2) the proportion of plasticizing agent is from about 10 to about 70 parts by weight per 100 parts by weight of the (meth)acrylate monomers and hydrophilic acidic monomers, the resultant adhesive formulations will provide a surprising combination of performance properties including quick stick to both wet and dry surfaces as well as high adhesion to both wet and dry surfaces. As a result of this heretofore unattained combination of performance properties, compositions of the invention can provide surprising, heretofore unattained advantages. The quick stick, high tack character of adhesives of the invention makes them easier to use than comparable adhesives which do not exhibit such properties, and which are thus, more susceptible to being moved or dislodged undesirably from selected location. Such quick stick, high tack is exhibited with both wet surfaces and dry surfaces, making adhesives of the invention suitable for use in a broad range of contexts.

Briefly, in one aspect of the present invention, a pressure sensitive adhesive is provided wherein the pressure sensitive adhesive comprises the polymerization product of:
(a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(b) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(c) about 10 to about 70 parts based on 100 parts (a)+(b) of a non-reactive plasticizing agent.
   Such adhesive compositions have been discovered to adhere surprisingly quickly to wet substrate surfaces.

Advantageously, the pressure sensitive adhesives of the present invention are hydrophilic in character, but do not suffer the problems as described in the art. Heretofore unknown, the adhesives of the present invention provide quick stick, high tack (i.e., an ASTM D3121 rolling ball tack value of less than 60 mm within 30 seconds of application), and high adhesion (i.e., a 180° peel adhesion of greater than 10 N/dm) to both wet and dry surfaces.

In another aspect of the present invention, a hot melt pressure sensitive adhesive is provided wherein the hot melt pressure sensitive adhesive comprises a wet stick pressure sensitive adhesive having a flow temperature and a thermoplastic packaging material enveloping said wet stick pressure sensitive adhesive, said thermoplastic packaging material having a melting temperature lower than the flow temperature of the wet stick pressure sensitive adhesive, wherein said pressure sensitive adhesive comprises the polymerization product of:
(a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(b) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(c) about 10 to about 70 parts based on 100 parts (a)+(b) of a non-reactive plasticizing agent.

In yet another aspect of the present invention, an article is provided wherein the article comprises a substrate; and a hot melt pressure sensitive adhesive applied to a surface of said substrate, said hot melt adhesive comprising a mixture of a pressure sensitive adhesive having a flow temperature and a thermoplastic material having a melting temperature that is less than the flow temperature of the pressure sensitive adhesive, said pressure sensitive adhesive comprising
(a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(b) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(c) about 10 to about 70 parts based on 100 parts (a)+(b) of a non-reactive plasticizing agent.

In yet another aspect of the present invention, a method for preparing a pressure sensitive adhesive is provided wherein the method comprises the steps of:
(a) combining a solventless polymerizable mixture comprising:
   (i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
   (ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
   (iii) about 10 to about 70 parts based on 100 parts of the sum of components (i) +(ii) of a non-volatile, non-reactive plasticizing agent; and
(b) polymerizing the solventless polymerizable mixture to yield the pressure sensitive adhesive.

In yet another aspect of the present invention, a method for preparing a hot melt pressure sensitive adhesive is provided wherein the method comprises the steps of:
(a) combining a solventless polymerizable mixture comprising:
   (i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
   (ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
   (iii) about 10 to about 70 parts based on 100 parts of the sum of components (i)+(ii) of a non-volatile, non-reactive plasticizing agent;
(b) enveloping the polymerizable mixture in a thermoplastic packaging material; and
(c) polymerizing the solventless polymerizable mixture to form the pressure sensitive adhesive that adheres within about 30 seconds to wet substrate surfaces, said pressure sensitive adhesive having a flow temperature,
   wherein the thermoplastic packaging material has a melting temperature lower than the flow temperature of the pressure sensitive adhesive.

In yet another aspect of the present invention, a method for preparing a hot melt pressure sensitive adhesive is provided wherein the method comprises the steps of:
(a) combining a solventless polymerizable mixture comprising:
   (i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
   (ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
   (iii) about 10 to about 70 parts based on 100 parts of the sum of components (i) +(ii) of a non-volatile, non-reactive plasticizing agent;
(b) enveloping the polymerizable mixture in a thermoplastic packaging material; and
(c) exposing the enveloped polymerizable mixture to sufficient radiation to polymerize the polymerizable mixture and to form the pressure sensitive adhesive that adheres within about 30 seconds to wet substrate surfaces, said pressure sensitive adhesive having a flow temperature,
   wherein the thermoplastic packaging material has a melting temperature lower than the flow temperature of the pressure sensitive adhesive.

In yet another aspect of the present invention, a method for preparing a hot melt pressure sensitive adhesive is provided wherein the method comprises the steps of:
(a) preparing a prepolymeric syrup comprising:
   (i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.; and
   (ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.;
(b) combining the prepolymeric syrup with about 10 to about 70 parts based on 100 parts of the sum of components (i) +(ii) of a non-reactive plasticizing agent to form a polymerizable mixture;
(c) enveloping the prepolymeric syrup in a thermoplastic packaging material; and
(d) exposing the enveloped prepolymeric syrup to sufficient radiation to polymerize the prepolymeric syrup and to yield the pressure sensitive adhesive.

In yet another aspect of the present invention, a method for preparing a pressure sensitive adhesive is provided wherein the method comprises the steps of:
(a) combining a solventless polymerizable mixture comprising:
   (i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.; and
   (ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.;
(b) polymerizing the solventless polymerizable mixture; and
(c) adding about 10 to about 70 parts based on 100 parts of the sum of components (i) +(ii) of a non-volatile, non-reactive plasticizing agent, to yield the pressure sensitive adhesive.

The adhesives and methods for forming them can be used to make a variety of useful adhesive articles such as tapes, pavement markings, labels, patches, etc.

As used herein in this application, the following terms and acronyms have the indicated meaning.

“Pressure-sensitive adhesive” or “pressure sensitive adhesive” or “PSA” refers to a viscoelastic material that possesses the following properties: (1) aggressive and permanent tack, (2) adherence with no more than finger pressure, and (3) sufficient ability to hold onto a substrate.

“Wet-stick adhesive” refers to a material that exhibits pressure-sensitive adhesive properties when adhered to a substrate that has been flooded with water. Wet-stick adhesives generally may or may not demonstrate pressure-sensitive adhesive properties under dry conditions. Adhesives of the invention are wet-stick adhesives and do demonstrate pressure sensitive adhesive properties under dry conditions.

“Hot melt adhesive” refers to a material that is heated to above room or ambient temperature to increase flow or tendency to wet an adherend, resulting in bond upon cooling to ambient temperature. Hot melt adhesives may or may not exhibit a degree of pressure sensitive character”

“Quick-stick” refers to the ability to form a bond within about 30 seconds of application.

“High-tack” refers to adhesive tack value of less than 60 mm as measured by rolling ball test using ASTM D3121.

“High-adhesion” refers to 180° peel adhesion to a substrate of greater than 10 N/dm as measured using an Instrumentors Inc. Model SP-102C testing unit.

“(Meth)acrylate monomers” or “(meth)acrylate ester monomers” are acrylic acid esters or methacrylic acid esters of non tertiary alcohols, the alcohols preferably having 4 to 12 carbon atoms, and any terms beginning with “(meth)acryl” are similarly intended to be inclusive of “acryl” and “methacryl”.

“Hydrophilic acidic monomers” or “hydrophilic acidic comonomers” are water soluble ethylenically unsaturated, free radically reactive monomers having carboxylic, sulfonic or phosphonic acid functionality and are copolymerizable with the (meth)acrylate monomers.

“Compatible” when used in relation to plasticizing agents refers to agents that:
(1) exhibit no gross phase separation from the wet stick adhesive composition when blended in the prescribed amounts,
(2) once mixed with the wet stick adhesive composition, do not significantly phase separate from the wet stick adhesive composition upon aging,
(3) function as a rheological modification agent for the wet stick adhesive composition, such that the plasticized composition exhibits pressure-sensitive properties as defined above, and
(4) promote high conversion polymerization, that is greater than about 98% polymerization of the comonomers.

“Non-reactive” refers to plasticizing agents that do not contain free radically reactive ethylenically unsaturated groups that could co-react with the comonomers, or functionalities that significantly inhibit the polymerization of these monomers.

“Non-volatile” refers to plasticizing agents that, when present in the wet stick adhesive composition of this invention, generate less than about 3% VOC (volatile organic content). The VOC content can be determined analogously to ASTM D 5403-93 by exposing the coated composition to 100° ±5° C. in a forced draft oven for 1 hour. If less than about 3% plasticizing agent is lost from the plasticized pressure-sensitive adhesive composition, the plasticizing agent is considered “non-volatile”. “Solventless” refers to wet-stick adhesive polymerizable mixtures that, once polymerized, are essentially 100% solids systems. Usually, such polymerizable mixtures have no more than about 5% organic solvents or water, more typically no more than about 3% organic solvents or water. Most typically, such polymerizable mixtures are free of organic solvents and water.

### DETAILED DESCRIPTION OF ILLUSTRATIVE EMBODIMENT(S)

Generally, a wet-stick pressure-sensitive adhesive of the present invention comprises the polymerization product of:
(a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(b) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(c) about 10 to about 70 parts based on 100 parts (a) +(b) of a non-reactive plasticizing agent,
   wherein the pressure sensitive adhesive adheres quickly to wet substrate surfaces.

When producing wet stick adhesives based on (meth)acrylate copolymers having high levels of acidic comonomers, which, when polymerized in the absence of other comonomers, yield a polymer or copolymer having a T_{g} of greater than about 40° C., applicants discovered that altering the relative ratios of the monomers, and/or altering the relative ratios of the combined monomers to the hydrophilic plasticizer, failed to provide a desirable quick stick property in a wet stick adhesive, nor did such adhesives provide quick bonds in the absence of moisture. Altering the molecular weights of the adhesive polymers also failed to provide the desired effects. Since adhesion to wet surfaces, such as wet asphalt surfaces and other wet pavement surfaces, is quite unpredictable, often not following adhesive-formulation rules of thumb otherwise applicable to adhesion to dry surfaces, applicants sought experimentally to find formulations which would provide quick stick to wet surfaces along with good adhesion to dry surfaces.

(Meth)Acrylate Monomers

The wet-stick adhesives of the present invention contain at least one monofunctional unsaturated monomer selected from the group consisting of (meth)acrylate esters of non-tertiary alkyl alcohols, the alkyl groups of which preferably comprise from 4 to 12, more preferably 4 to 8 carbon atoms; and mixtures thereof. Preferred (meth)acrylate monomers have the following general Formula (I):

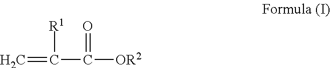

wherein R¹ is H or CH₃, the latter corresponding to where the (meth)acrylate monomer is a methacrylate monomer. R² is broadly selected from linear or branched hydrocarbon groups and may contain one or more heteroatoms. The number of carbon atoms in the hydrocarbon group is preferably 4 to 12, and more preferably 4 to 8.

Examples of suitable (meth)acrylate monomers useful in the present invention include, but are not limited to, n-butyl acrylate, decyl acrylate, 2-ethylhexyl acrylate, hexyl acrylate, isoamyl acrylate, isodecyl acrylate, isononyl acrylate, isooctyl acrylate, lauryl acrylate, 2-methyl butyl acrylate, 4-methyl-2-pentyl acrylate, ethoxy ethoxyethyl acrylate, 2-octyl acrylate. Also suitable are monomers comprising structural isomers of a secondary alkyl (meth)acrylate and mixtures thereof, as described in US Published Patent Application No. 2013/0260149 (Clapper et al.). Particularly preferred are n-butyl acrylate, 2-ethylhexyl acrylate, isooctyl acrylate, lauryl acrylate, and mixtures thereof.

Hydrophilic Acidic Comonomers

Useful hydrophilic acidic comonomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, beta-carboxyethyl acrylate, 2-sulfoethyl methacrylate, styrene sulfonic acid, 2-acrylamido-2-methylpropane sulfonic acid, vinyl phosphonic acid, and the like, and mixtures thereof. Due to their availability and effectiveness in reinforcing (meth)acrylate pressure sensitive adhesives, particularly preferred hydrophilic acidic monomers are the ethylenically unsaturated carboxylic acids. Beta-carboxyethyl acrylate can be a preferred hydrophilic acidic comonomer. Acrylic acid can be a preferred hydrophilic acidic comonomer when used in combination with one or more other hydrophilic acidic monomer(s) to meet the other criteria of the present invention.

Minor amounts of monomers copolymerizable with the (meth)acrylate monomers and hydrophilic acidic monomers can be used. Examples of such monomers include (meth)acrylamides, vinyl esters and N-vinyl lactams.

The copolymerizable mixture of the present invention comprises, based upon 100 parts by weight total, about 30 to about 70 parts by weight of one or more (meth)acrylate ester monomers wherein the (meth)acrylate ester monomers, that when polymerized in the absence of other comonomers yield a polymer or copolymer having a T_{g} of less than about 10° C., and about 70 to about 30 parts by weight of one or more hydrophilic acidic monomers wherein the hydrophilic acidic monomers, that when polymerized in the absence of other comonomers yield a polymer or copolymer having a T_{g} of less than about 40° C.

Preferably, the copolymerizable mixture of the present invention comprises about 35 to about 65 parts by weight of one or more (meth)acrylate monomers and about 65 to about 35 parts by weight of one or more hydrophilic acidic comonomers. More preferably, the copolymerizable mixture of the present invention comprises about 40 to about 60 parts by weight of one or more (meth)acrylate monomers and about 60 to about 40 parts by weight of one or more hydrophilic acidic comonomers.

The ratio and type of each comonomer in the wet stick adhesive composition can be chosen to optimize the performance. For example, the use of beta-carboxyethyl acrylate as a hydrophilic acidic comonomer in conjunction with isooctyl acrylate as a (meth)acrylate comonomer can surprisingly provide a polymer system that, once combined with a suitable plasticizing agent, will provide a quick stick, high tack, high adhesion adhesive that adheres to both wet and dry surfaces. However, a similar system made with acrylic acid as the only hydrophilic acidic comonomer will not provide a quick stick, high tack, high adhesion adhesive that adheres to both wet and dry surfaces.

Further, the use of beta-carboxyethyl acrylate as a hydrophilic acidic comonomer in conjunction with isooctyl acrylate as a (meth)acrylate comonomer can provide a polymerization mixture which does not require the presence of a compatibilizing plasticizing agent during polymerization. This adds considerable process versatility.

Both the (meth)acrylate monomers and the hydrophilic acidic comonomers preferably have a diacrylate content less than about 100 ppm.

Plasticizing Agents

The plasticizing agents selected for use in the wet stick adhesive compositions of the present invention possess several properties. Some (meth)acrylate monomers and some hydrophilic acidic comonomers are inherently incompatible co-reactants and, without a solvent or aqueous reaction medium, fail to significantly interpolymerize. For some such combinations, the plasticizing agent can play the role of reaction solvent.

The plasticizing agent is also compatible with the polymerized wet-stick adhesive composition. Since the plasticizing agent also modifies the rheology and transforms the copolymer into a material having wet-stick adhesive properties, the plasticizing agent should be compatible with the copolymer. Any significant plasticizer bleeding or migration from the composition could result in loss of wet-stick adhesion properties.

Useful plasticizing agents are compatible with the wet stick adhesive composition, such that once the plasticizing agent is mixed with the comonomers or wet stick adhesive composition, the plasticizing agent does not phase separate. By “phase separation” or “phase separate”, it is meant that by differential scanning calorimetry (DSC) no detectable thermal transition, such as a melting or glass transition temperature, can be found for the pure plasticizing agent in the wet stick adhesive composition. Some migration of the plasticizing agent from or throughout the wet stick adhesive composition can be tolerated, such as minor separation due to composition equilibrium or temperature influences, but the plasticizing agent does not migrate to the extent of phase separation between the wet stick adhesive composition and the plasticizing agent. Plasticizing agent compatibility with the wet stick adhesive composition can also be determined by the chemical nature of the plasticizing agent and the comonomers. For example, polymeric plasticizing agents based on polyether backbones (such as polyethylene glycols) are observed to be more compatible than polyester plasticizing agents, especially when higher levels of acidic comonomer such as acrylic acid are used.

For these same reasons, the plasticizing agent is also non-volatile. The plasticizing agent must remain present and stable under polymerization reaction conditions in order to serve as a polymerization medium for marginally compatible (meth)acrylate monomers and hydrophilic acidic comonomers. To maintain wet-stick adhesion properties, the plasticizing agent must again remain present and not significantly evaporate from the polymerized wet-stick adhesive composition.

Additionally, the plasticizing agent is non-reactive to prevent reaction or interference with the polymerization of the copolymer formed from the (meth)acrylate monomers and hydrophilic acidic comonomers. Thus, plasticizing agents having acrylate functionality, methacrylate functionality, styrene functionality, or other ethylenically unsaturated free radically reactive functional groups are not used. Non-reactive plasticizing agents also reduce the inhibition or retardation of the polymerization reaction and/or the alteration of the final polymer structure that can occur if the plasticizing agent acts as a chain-transfer or chain-terminating agent. Such undesirable effects can adversely influence the performance and stability of the materials polymerized in the presence of these plasticizing agents. Chain termination can also result in undesirably high residual volatile materials (i.e., lower conversion of the comonomers).

Particularly useful plasticizing agents include polyalkylene oxides having weight average molecular weights of about 150 to about 12,000, or of about 150 to about 5,000, or of about 150 to about 1,500, and which are liquids at room temperature. These include polyethylene oxides; polypropylene oxides; random copolymers of polyethylene oxides and polypropylene oxides available as UCON™ fluids (from Dow Chemical) having number average molecular weights from about 270 to about 12000; polyethylene glycols; alkyl or aryl functionalized polyalkylene oxides, such as PYCAL™ 94 (a phenyl ether of polyethylene oxide, from ICI Chemicals); benzoyl functionalized polyethers, such as BENZOFLEX™ 400 (polypropylene glycol dibenzoate, from Velsicol Chemicals); monomethyl ethers of polyethylene oxides; and mixtures thereof.

The plasticizing agent can be used in amounts of from about 10 to about 70 parts by weight per 100 parts of the (meth)acrylate monomers and hydrophilic acidic comonomers. The amount of plasticizer required depends upon the type and ratios of the (meth)acrylate monomers and hydrophilic acidic comonomers employed in the polymerizable mixture and the chemical class and molecular weight of the plasticizing agent used in the composition. It may be possible, depending on the type and ratios of the (meth)acrylate monomers and hydrophilic acidic comonomers employed in the polymerizable mixture, to employ no plasticizing agent during all, or the beginning portions, of the polymerization reaction, and add the plasticizing agent only at the “prepolymeric syrup” stage of the reaction, or even after polymerization is complete.

Initiators

A free radical initiator is preferably added to aid in the copolymerization of (meth)acrylate comonomers and acidic comonomers. The type of initiator used depends on the polymerization process. Photoinitiators which are useful for polymerizing the polymerizable mixture monomers include benzoin ethers such as benzoin methyl ether or benzoin isopropyl ether, substituted benzoin ethers such as 2-methyl-2-hydroxypropiophenone, aromatic sulfonyl chlorides such as 2-naphthalenesulfonyl chloride, and photoactive oxides such as 1-phenyl-1,1-propanedione-2-(o-ethoxycarbonyl)oxime. An example of a commercially available photoinitiator suitable for use in many embodiments is IRGACURE™ 651 (2,2-dimethoxy-1,2-diphenylethane-1-one, from Ciba-Geigy Corporation). Generally, the photoinitiator is present in an amount of about 0.005 to about 1 weight percent based on the weight of the copolymerizable monomers. Examples of suitable thermal initiators include AIBN (i.e., 2,2′-azobis(isobutyronitrile), hydroperoxides, such as tert-butyl hydroperoxide, and peroxides, such as benzoyl peroxide and cyclohexane peroxide.

Chain Transfer Agents

Optionally, the composition also includes a chain transfer agent to control the molecular weight of the polymerized compositions. Chain transfer agents are materials that regulate free radical polymerization and are generally known in the art. Suitable chain transfer agents include halogenated hydrocarbons such as carbon tetrabromide; sulfur compounds such as lauryl mercaptan, butyl mercaptan, ethanethiol, isooctylthioglycolate (IOTG), 2-ethylhexyl thioglycolate, 2-ethylhexyl mercaptopropionate, 2-mercaptoimidazole, and 2-mercaptoethyl ether and mixtures thereof.

The amount of chain transfer agent that is useful depends upon the desired molecular weight and the type of chain transfer agent. The chain transfer agent is typically used in amounts from about 0.001 part to about 10 parts by weight per 100 parts of total monomer, and preferably from about 0.01 part to about 0.5 part, and most preferably from about 0.02 part to about 0.20 part.

Solventless Polymerization Processes

Solventless polymerization methods, such as the continuous free radical polymerization method described in U.S. Pat. No. 4,619,979 (Kotnour et al.) and U.S. Pat. No. 4,843,134 (Kotnour et al.); the essentially adiabatic polymerization methods using a batch reactor described in U.S. Pat. No. 5,637,646 (Ellis); and, the methods described for polymerizing packaged polymerizable mixtures described in U.S. Pat. No. 5,804,610 (Hamer et al.) may also be utilized to prepare the polymers.

In one preferred embodiment of this latter method, from about 0.1 to about 500 g of the polymerizable mixture comprising the (meth)acrylate monomers, hydrophilic acidic comonomers, plasticizing agent, initiator, and optional chain transfer agent is completely surrounded by a packaging material. In another preferred embodiment, from about 3 to about 100 g of the polymerizable mixture is surrounded by the packaging material. In another embodiment of the invention, the polymerizable mixture is substantially surrounded by the packaging material. In yet another embodiment, the polymerizable mixture is disposed on the surface of a sheet, or between a pair of two substantially parallel sheets of the packaging material. In another embodiment of the invention, the polymerizable mixture is substantially or completely surrounded by a hollow profile of packaging material with a length:square root of the cross-sectional area ratio of at least about 30:1.

The packaging material is made of a material that when combined with the adhesive does not substantially adversely affect the desired adhesive characteristics. A hot melt coated adhesive produced from a mixture of the adhesive and the packaging material may have improved adhesive properties compared to hot melt coated adhesive produced from adhesive alone.

The packaging material preferably melts at or below the processing temperature of the adhesive (i.e., the temperature at which the adhesive flows, or the flow temperature). The packaging material preferably has a melting point, or melting temperature, of about 200° C. or less, preferably about 170° C. or less. In a preferred embodiment the melting point ranges from about 90° C. to about 150° C. The packaging material may be a flexible thermoplastic polymeric film. The packaging material is preferably selected from ethylene-vinyl acetate, ethylene-acrylic acid, polypropylene, polyethylene, polybutadiene, or ionomeric films. In a preferred embodiment the packaging material is an ethylene-acrylic acid or ethylene-vinyl acetate film.

The amount of packaging material depends upon the type of material and the desired end properties. The amount of packaging material typically ranges from about 0.5 percent to about 20 percent of the total weight of the polymerization mixture and the packaging material. Preferably, the packaging material is from about 2 percent to about 15 percent by weight, and more preferably from about 3 percent to about 5 percent. Such packaging materials may contain plasticizers, stabilizers, dyes, perfumes, fillers, slip agents, antiblock agents, flame retardants, anti-static agents, microwave receptors, thermally conductive particles, electrically conductive particles, and/or other materials to increase the flexibility, handleability, visibility, or other useful property of the film, as long as they do not adversely affect the desired properties of the adhesive.

The packaging material should be appropriate for the polymerization method used. For example, with photopolymerization, it is necessary to use a film material that is sufficiently transparent to ultraviolet radiation at the wavelengths necessary to effect polymerization.

The transmissive energy may be selected from ultraviolet radiation, visible radiation, thermal radiation, or thermal conduction. The transmissive energy is preferably ultraviolet radiation or thermal conduction. Preferably, at least about 80 percent of the pre-adhesive is converted to adhesive; more preferably, at least about 90 percent of the pre-adhesive is converted to adhesive.

Thermal polymerization can be effected by immersing the packaged composition in a heat exchange medium at temperatures from about 40° C. to about 100° C. for a time sufficient to polymerize the composition. The heat exchange medium may be a forced or impinged gas or a liquid such as water, perfluorinated liquids, glycerin, or propylene glycol. The heat necessary for thermal polymerization may also be provided by a metal platen, heated metal rolls, or microwave energy.

The temperature at which the polymerization occurs depends upon the activation temperature of the initiator. For example, polymerization using VAZO™ 64, a commercially available initiator from DuPont Company can be carried out at about 65° C., while VAZO™ 52, also from DuPont Company, can be used at about 45° C.

It is preferable to carry out the polymerization in an appropriate liquid heat exchange medium at a controlled temperature. A suitable liquid heat exchange medium is water, heated to the desired reaction temperature. Commercially available heat transfer fluids may also be used. Additional information concerning thermal polymerization may be found in U.S. Ser. No. 08/234,468, filed Apr. 26, 1994, entitled “Thermal Free-Radical Cure Adhesives and Articles Made Thereby”.

Polymerization can also be effected by exposure to ultraviolet (UV) radiation as described in U.S. Pat. No. 4,181,752 (Martens et al.). In a preferred embodiment, the polymerization is carried out with UV black lights having over 60 percent, and preferably over 75 percent of their emission spectra from about 280 to about 400 nm, with an intensity from about 0.1 to about 25 mW/cm².

During photopolymerization it is desirable to control the temperature by blowing cooling air around the packaged polymerizable mixture, by running the packaged polymerizable mixture over a cooled platen, or by immersing the packaged polymerizable mixture in a water bath or a heat transfer fluid during polymerization. Preferably, the packaged polymerizable mixtures are immersed in a water bath, with water temperatures from about 5° C. to 90° C., preferably below about 30° C. Agitation of the water or fluid helps to avoid hot spots during the reaction.

The packaged polymerized wet-stick adhesive compositions may be used to make a coatable hot melt adhesive by introducing the adhesive and its packaging material into a vessel in which the adhesive and its packaging material are melted. This hot melt adhesive may be used to form a pressure sensitive adhesive sheet by coating the melted adhesive and its packaging material onto a sheet material or another suitable substrate. The sheet material is preferably selected from a tape backing or a release liner. Preferably, the polymerized adhesives are hot melt coated by putting the packaged adhesive in a hot melt coater at a temperature sufficient to melt the packaged adhesive and with sufficient mixing to form a coatable mixture, which is coated onto a substrate. This step can be done conveniently in a heated extruder, bulk tank melter, melt-on-demand equipment, or a hand-held hot melt adhesive gun.

In an alternative embodiment, the plasticizing agent may be omitted, in whole or in part, from the polymerizable mixture. Then, when the packaged polymerized wet-stick adhesive, lacking some or all of the intended amount of plasticizing agent, is introduced to a vessel in which the adhesive and its packaging material are melted, such as a heated extruder, bulk tank melter, melt-on-demand equipment, or a hand-held hot melt adhesive gun, the plasticizing agent or remainder of the plasticizing agent may be also introduced thereto. This is an advantage of the present invention. It has been discovered that by using monomer mixtures that meet the requirements of the present invention, the polymerization step may be effectively carried out with less of the plasticizing agent than the amount desired in the final adhesive, or with no plasticizing agent at all.

For any of these embodiments, the coatable hot melt adhesive can then be delivered out of a film die, subsequently contacting the drawn adhesive to a moving plastic web or other suitable substrate. A related coating method involves extruding the coatable hot melt adhesive and a coextruded backing material from a film die and cooling the layered product to form an adhesive tape. Other forming methods involve directly contacting the coatable hot melt adhesive to a rapidly moving plastic web or other suitable preformed substrate. Using this method, the adhesive blend is applied to the moving preformed web using a die having flexible die lips, such as a rotary rod die. After forming by any of these continuous methods, the adhesive films or layers can be solidified by quenching using both direct methods (e.g., chill rolls or water baths) and indirect methods (e.g., air or gas impingement).

The packaged adhesive composition may further comprise an effective amount of a crosslinking agent that may be activated after the adhesive has been hot melt coated. Typically, the amount ranges from about 0.01 to about 5.0 parts based upon 100 parts of the (meth)acrylate monomers and the hydrophilic acidic comonomers. The crosslinking agent can be added to the polymerized adhesive before or during hot melt coating, or it can be added to the polymerizable mixture. When added to the polymerizable mixture, the crosslinking agent can remain intact as a separate species in the adhesive, or it can be co-polymerized with the monomers. Crosslinking is preferably initiated after hot melt coating, and the crosslinking is preferably initiated by ultraviolet radiation, or ionizing radiation such as gamma radiation or electron beam (the use of separate crosslinking agents being optional in the case of ionizing radiation). Preferred crosslinking agents that can be added after polymerization and before hot melt coating include multi-functional (meth)acrylates such as 1,6-hexanedioldiacrylate and trimethylolpropane triacrylate, and substituted triazines such as 2,4-bis(trichloromethyl)-6-(4-methoxyphenyl)-s-triazine and 2,4-bis(trichloromethyl)-6-(3,4-dimethoxyphenyl)-s-triazine, as described in U.S. Pat. No. 4,329,384 (Vesley et al.) and U.S. Pat. No. 4,330,590 (Vesley). Another class of preferred crosslinking agents are the copolymerizable mono-ethylenically unsaturated aromatic ketone comonomers free of ortho-aromatic hydroxyl groups such as those disclosed in U.S. Pat. No. 4,737,559 (Kellen et al.). Specific examples include para-acryloxybenzophenone, para-acryloxyethoxybenzophenone, para-N-(methylacryloxyethyl)-carbamoylethoxybenzophenone, para-acryloxyacetophenone, ortho-acrylamidoacetophenone, acrylated anthraquinones, and the like.

Yet another class of suitable crosslinking agents are the multifunctional radiation-activatable crosslinking agents described in PCT Patent Application WO 97/07161 (Stark et al.), and in U.S. Pat. No. 5,407,971 (Everaerts et al.). An example of these crosslinking agents is 1,5-bis(4-benzoylbenzoxy) pentane. Also suitable are hydrogen-abstracting carbonyls such as anthraquinone, benzophenone, and derivatives thereof, as disclosed in U.S. Pat. No. 4,181,752.

The acrylate copolymers can be crosslinked by exposure to ultraviolet radiation from, for example, medium pressure mercury arc lamps. It is preferred that crosslinking agents activated by ultraviolet radiation be primarily activated by a different wavelength of energy than that used for the polymerization. For example, low intensity black lights may be used for polymerization and mercury arc lamps may be used for the subsequent crosslinking.

The steps may be done in-line, i.e., the polymerizable mixture may be surrounded by the packaging material, polymerized, hot melt coated to form a tape, and optionally crosslinked, or the steps may be performed individually at separate times and sites. For example, the packaged prepolymeric mixture may be polymerized at one time, and extruded and crosslinked at another time.

In another preferred bulk polymerization method, the wet-stick (meth)acrylate pressure sensitive adhesives of the present invention are prepared by photoinitiated polymerization methods of the technique described in U.S. Pat. No. 4,181,752. The (meth)acrylate monomers, hydrophilic acidic comonomers, plasticizing agent and a photoinitiator are mixed together in the absence of solvent and partially polymerized to a viscosity in the range of from about 500 cps to about 50,000 cps to achieve a coatable syrup. Alternatively, the (meth)acrylate monomers, hydrophilic acidic comonomers, plasticizing agent may be mixed with a thixotropic agent such as fumed hydrophilic silica to achieve a coatable thickness. The crosslinking agent and any other ingredients are then added to the prepolymeric syrup. Alternatively, these ingredients (with the exception of the crosslinking agent) can be added directly to the monomer mixture prior to pre-polymerization.

The resulting composition is coated onto a substrate (which may be transparent to ultraviolet radiation) and polymerized in an inert (i.e., oxygen free) atmosphere, e.g., a nitrogen atmosphere by exposure to ultraviolet radiation. Examples of suitable substrates include release liners (e.g., silicone release liners) and tape backings (which may be primed or unprimed paper or plastic). A sufficiently inert atmosphere can also be achieved by covering a layer of the polymerizable coating with a plastic film which is substantially transparent to ultraviolet radiation, and irradiating through that film in air as described in the aforementioned patent using ultraviolet lamps. Alternatively, instead of covering the polymerizable coating, an oxidizable tin compound may be added to the polymerizable syrup to increase the tolerance of the syrup to oxygen as described in U.S. Pat. No. 4,303,485. The ultraviolet light source preferably has 90% of the emissions from about 280 to about 400 nm (more preferably from about 300 to about 400 nm), with a maximum at about 351 nm.

The polymerizable mixture may also contain a crosslinking agent, or a combination of crosslinking agents, to increase the shear strength of the adhesive. Useful crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590. Other useful crosslinking agents include multifunctional alkyl (meth)acrylate monomers such as trimetholpropane triacrylate, pentaerythritol tetra-acrylate, 1,2 ethylene glycol diacrylate, 1,4 butanediol diacrylate, 1,6 hexanediol diacrylate, and 1,12 dodecanol diacrylate. Various other crosslinking agents with different molecular weights between (meth)acrylate functionality would also be useful. Generally, the crosslinker is present in an amount of about 0.005 to about 1 weight percent based on the combined weight of the monomers.

Other Additives

Other additives can be included in the polymerizable mixture or added at the time of compounding or coating to change the properties of the adhesive. Such additives, or fillers, include pigments, glass or polymeric bubbles or beads (which may be expanded or unexpanded), fibers, reinforcing agents, hydrophobic or hydrophilic silica, toughening agents, fire retardants, antioxidants, finely ground polymeric particles such as polyester, nylon, and polypropylene, and stabilizers. The additives are added in amounts sufficient to obtain the desired end properties.

The wet stick pressure sensitive adhesives of the present invention that provide quick stick, high tack, and high adhesion to both wet and dry surfaces are useful in many industrial, commercial and consumer applications. For example, these quick stick, high tack, high adhesion wet stick adhesives are useful in medical applications, such as tapes, bandages, dressings, and drapes to adhere to dry and to moist skin surfaces such as wounds or areas of the body prone to moistness. Additionally, quick stick, high tack, high adhesion adhesives wet stick adhesives also find use in outdoor or exterior applications, such as on roadway materials, such as pavement surfaces such as asphalt pavement, and in pavement marking tapes, traffic control signage, and marine or automotive coatings and surfaces. Furthermore, labels for food containers and other products that are exposed to moisture due to condensation or subjected to water or ice immersion also can be coated with quick stick, high tack, high adhesion dry- and wet-stick adhesives.

This invention is further illustrated by the following examples that are not intended to limit the scope of the invention. In the examples, all parts, ratios and percentages are by weight unless otherwise indicated. The following test methods were used to evaluate and characterize the wet stick adhesive compositions produced in the examples. All materials are commercially available, for example from Aldrich Chemicals (Milwaukee, WI), unless otherwise indicated or described.

### EXAMPLES

The invention will be further illustrated with reference to the following non-limiting examples.

All amounts are in parts by weight unless otherwise indicated. Several abbreviations and units are used in the description including the following:

| Abbreviation | Meaning |
|---|---|
| cc/rev | cubic centimeter/revolution |
| cm | centimeter |
| cm/min. | centimeter/minute |
| ° C. | Centigrade |
| Cps | centipoise |
| g | gram |
| g/m² | gram/square meter |
| Hr | hour |
| Kg | Kilogram |
| min | minutes |
| ml | milliliter |
| mm | millimeter |
| mW | milliWatt |
| Nm | nanometer |
| N/dm | Newtons/decimeter width |
| ppm | parts per million |
| 2EHA | 2-ethylhexyl acrylate |
| AA | acrylic acid |
| B-CEA | beta-carboxyethyl acrylate |
| UCON | UCON ™ Fluids from The Dow Chemical Company |
| BRIJ 30 | polyoxyethylene (4) lauryl ether, from ICI Americas, Inc. |
| BRIJ 52 | polyoxyethylene 10 olelyl ether, from ICI Americas, Inc. |
| HDDA | hexanediol diacrylate, from Sartomer |
| IOA | isooctyl acrylate |
| IOTG | isooctyl thioglycolate |
| IRG 651 | IRGACURE ™ 651, 2,2-dimethoxy-2-phenyl acetophenone photoinitiator, |
| | from Ciba Geigy Co. |
| IRG 184 | IRGACURE ™ 184, hydroxycyclohexyl phenyl ketone photoinitiator, from |
| | Ciba Geigy Co. |
| IRG 1076 | IRGANOX ™ 1076, octadecyl 8 (3,5-tert-butyl-4-hydroxyphenol) propionate |
| | antioxidant, from Ciba Geigy Co. |
| LA | lauryl acrylate |
| MPEG 550 | CARBOWAX ™ MPEG 550, methoxypolyethylene glycol having a molecular |
| | weight of approximately 550, from Union Carbide Corp. |
| PPG 1000 | polypropylene glycol having molecular weight of approximately 1000, from |
| | Aldrich Chemical |
| PYCAL 94 | phenyl ether of polyethylene oxide plasticizer, from ICI Chemicals, Inc. |
| TMN-3 | TERGITOL ™ TMN-3, 2,6,8-trimethyl-4-nonoxy ether of polyethylene oxide |
| | having a molecular weight of 312, from Union Carbide Corp. |
| TRITON X35 | TRITON ™ Nonionic Surfactant X-35, octylphenoxy ether of polyethylene |
| | oxide having 3 ethylene oxide repeating units, from Union Carbide Corp. |
| TRITON X114 | TRITON ™ Nonionic Surfactant X-35, octylphenoxy ether of polyethylene |
| | oxide having 7-8 ethylene oxide repeating units, from Union Carbide Corp. |

### Test Methods

Peel Adhesion to Stainless Steel:

Peel adhesion is the force required to remove an adhesive-coated, flexible sheet material from a stainless steel test panel. Peel adhesion is measured at a specific angle of 180° and rate of removal of 30.5 cm/minute. Peel adhesions in the range of 5 N/dm or higher, as measured by the following procedure are generally considered acceptable as wet stick adhesives of the present invention. Peel adhesions greater than 10 N/dm are considered to be “high adhesion” of the present invention.

Dry peel adhesion to stainless steel: A strip (2.54 centimeter wide) of the adhesive-coated sheet was applied to the horizontal surface of a clean, polished #405 stainless steel test plate with at least 5 lineal centimeters of both surfaces being in firm contact. Two passes with a with a 2 kg hard rubber roller were used to laminate the strip to the plate. The free end of the coated strip was doubled back nearly touching itself so the angle of removal was 180°. The free end was attached to the adhesion tester scale. The stainless steel test plate was clamped in the jaws of a tensile testing machine (Instrumentors Inc. Model SP-102C) that was capable of moving the plate away from the scale at a constant rate of 30.5 centimeters/minute. The scale reading was recorded in Newtons as the tape was peeled from the steel surface. The data was reported as the average of the range of numbers observed during the test. The time elapsed, from rolling with the 2 kg hard rubber roller to laminate, to running the peel test, was less than 30 seconds.

Wet peel adhesion to stainless steel: The surface of a polished #405 stainless steel plate was roughened using 100 grit sandpaper until the plate had a measured average surface roughness (Ra) of 0.35 micron to 0.50 micron using a Mahr Perthometer Model M2. The roughened plate was then immersed in a 21° C. water bath. A strip (2.54 centimeter wide) of the adhesive-coated sheet was immersed in the water bath and applied to the horizontal surface of the roughened test plate test plate with at least 5 lineal centimeters of both surfaces being in firm contact. While still immersed, two passes with a 2 kg hard rubber roller were used to laminate the strip to the plate. The free end of the coated strip was doubled back nearly touching itself so the angle of removal was 180°. The free end was attached to the adhesion tester scale. The stainless steel test plate was clamped in the jaws of a tensile testing machine (Instrumentors Inc. Model SP-102C) that was capable of moving the plate away from the scale at a constant rate of 30.5 centimeters/minute. The scale reading was recorded in Newtons as the tape was peeled from the steel surface. The data was reported as the average of the range of numbers observed during the test. The time elapsed, from rolling with the 2 kg hard rubber roller to laminate, to running the peel test, was less than 30 seconds.

Wet peel adhesion to asphalt: A 122 cm×122 cm sheet of smooth wear grade asphalt was prepared by paving a hot asphalt mix (Asphalt grade SPWEA240A as specified in MN DOT PLANT MIXED ASPHALT PAVEMENT specification 2360 (2013)) on to a wooden platform to a thickness of 5 cm. After cooling, the asphalt surface was saturated with water. A strip (7.6 centimeter wide) of the adhesive-coated sheet was applied to the wet asphalt and tamped down 6 times with a Roller Tamper Cart RTC-3 3M™ STAMARK™ using 91 kg of weight. One edge of the strip was placed in the jaws of a VISE-GRIP™ 8R Locking Sheet Metal Clamp. The clamp was then attached to an ACCUFORCE™ CADET FORCE GAGE 0-100 LB from Ametek, Inc., Mansfield & Green Division (Largo, Fla.). The adhesive coated strip was then peeled at a 90° angle from the asphalt at a rate of 30.5 cm/minute. The force was recorded in Newtons. The test was run 5 minutes after application and repeated 2 hours after application.

Dry peel adhesion to asphalt: A 122 cm×122 cm sheet of smooth wear grade asphalt was prepared by paving a hot asphalt mix (Asphalt grade SPWEA240A as specified in MN DOT PLANT MIXED ASPHALT PAVEMENT specification 2360 (2013)) on to a wooden platform to a thickness of 5 cm. After cooling, a strip (7.6 centimeter wide) of the adhesive-coated sheet was applied to the dry, clean asphalt and tamped down 6 times with a Roller Tamper Cart RTC-3 3M™ STAMARK™ using 91 kg of weight. One edge of the strip was placed in the jaws of a VISE-GRIP™ 8R Locking Sheet Metal Clamp. The clamp was then attached to an ACCUFORCE™ CADET FORCE GAGE 0-100 LB from Ametek Inc., Mansfield & Green Division (Largo, Fla.). The adhesive coated strip was then peeled at a 90° angle from the asphalt at a rate of 30.5 cm/minute. The force was recorded in Newtons. The test was run 5 minutes after application and repeated 2 hours after application.

Tack Test: A 300 mm strip (2.54 centimeter wide) of the adhesive-coated sheet was laid flat, adhesive coated side facing up. Tack was measured per ASTM D3121, rolling ball tack test, using a 1.11 cm diameter steel ball. Results are recorded as travel distance in mm of the steel ball. Travel distance of 60 mm or less is defined as high tack. For some applications, a higher tack corresponding to a travel distance of 30 mm or less, or even 10 mm or less, may be preferred.

### Examples 1-8, Comparative Examples C1-C7

### Preparation of Packaged Polymerized Acrylate Wet-Stick Adhesive Compositions

Packaged polymerized acrylate wet stick adhesive composition were packaged, polymerized, coated and tested of the following method: Two sheets of a heat sealable ethylene vinyl acetate film having a thickness of 64 micrometers and a 6 mole % vinyl acetate content (VA24, from Consolidated Thermoplastics Co.; Schaumburg, Ill.) were heat sealed on the lateral edges and the bottom to form a rectangular pouch measuring approximately 5 cm wide. The polymerizable mixtures comprising the (meth)acrylate monomers, hydrophilic acidic comonomers, plasticizing agent, initiators and chain transfer agents described in Table 1 were prepared and 20 ml of each mixture was delivered via syringe into the unsealed edge of the pouch. The unsealed edge of the filled pouch was then heat sealed to form 5 cm by 8.9 cm pouches each containing about 19 grams of the polymerizable mixture.

The pouches were placed in a water bath that was maintained at about 16° C. and exposed to ultraviolet radiation at an intensity of about 3.5 mW/cm² for about 8.5 minutes (UV Exp Time). The radiation was supplied from lamps having about 90% of the emissions from about 300 to about 400 nm, and a peak emission at 351 nm.

Table 1 lists the respective formulation by component and amount in parts by weight of each illustrative composition.

TABLE 1

| Ex. | Acrylate | | Acid | Plasticizing Agent | IOTG | IRG 651 | IRG 1076 |
|---|---|---|---|---|---|---|---|
| 1 | IOA | (50) | B-CEA (50) | UCON 50-HB-400 (53.8) | 0.06 | 0.44 | 0.2 |
| 2 | IOA | (50) | B-CEA (50) | UCON 50-HB-5100 (53.8) | 0.06 | 0.44 | 0.2 |
| 3 | IOA | (40) | B-CEA (60) | UCON 50-HB-400 (53.8) | 0.06 | 0.44 | 0.2 |
| 4 | IOA | (50) | B-CEA (50) | UCON 50-HB-400 (21.1) | 0.06 | 0.44 | 0.2 |
| 5 | IOA | (70) | B-CEA (30) | UCON 50-HB-400 (11.1) | 0.06 | 0.44 | 0.2 |
| 6 | IOA | (30) | B-CEA (70) | UCON 50-HB-400 (11.1) | 0.06 | 0.44 | 0.2 |
| 7 | IOA | (50) | B-CEA (50) | —* | 0.06 | 0.44 | 0.2 |
| 8 | 2-EHA | (50) | B-CEA (50) | —* | 0.06 | 0.44 | 0.2 |
| C-1 | IOA | (70) | B-CEA (30) | UCON 50-HB-400 (100) | 0.06 | 0.44 | 0.2 |
| C-2 | IOA | (50) | B-CEA (50) | UCON 50-HB-400 (100) | 0.06 | 0.44 | 0.2 |
| C-3 | IOA | (50) | B-CEA (50) | UCON 50-HB-400 (73.9) | 0.06 | 0.44 | 0.2 |
| C-4 | IOA | (30) | B-CEA (70) | UCON 50-HB-400 (100) | 0.06 | 0.44 | 0.2 |
| C-5 | IOA | (50) | AA (50) | UCON 50-HB-400 (100) | 0.06 | 0.44 | 0.2 |
| C-6 | IOA | (50) | AA (50) | UCON 50-HB-400 (53.8) | 0.06 | 0.44 | 0.2 |
| C-7 | IOA | (50) | AA (50) | UCON 50-HB-400 (11.1) | 0.06 | 0.44 | 0.2 |

*53.8 parts UCON 50-HB-400 added during extrusion and coating process

Materials of Examples 1 through 8, and Comparative Examples C-1 through C-7 were extruded onto 0.05 mm PET to a coating weight of 3.24 grams per 155 cm²using a twin screw extrusion process described in U.S. Pat. No. Re. 36,855 (Bredahl et al.) and used for dry adhesion, wet adhesion and tack testing.

Materials of Example 1 and Comparative Example C-6 were extruded onto 0.05 mm silicone coated PET to a coating weight of 6.5 grams per 155 cm² using a twin screw extrusion process described in U.S. Pat. No. Re. 36,855 (Bredahl et al.). These adhesive-laden silicone-coated PET sheets were then laminated to 1.5 mm thick nitrile rubber pavement marking film as described in Example 10 of U.S. Pat. No. 4,490,432 (Jordan), and the silicon-coated PET film was stripped off, leaving the adhesive upon the nitrile rubber pavement marking film. These specimens were used for dry adhesion to asphalt and wet adhesion to asphalt testing.

### Examples 9-11, Comparative Examples C8-C10

### Preparation of “Syrup” Acrylate Wet-Stick Adhesive Compositions

Examples 9-11 and Comparative Examples C8-C10 were made via the technique described in U.S. Pat. No. 4,181,752.

Table 2 lists the respective formulation by component and amount in parts by weight (except HDDA which is in ppm) of each illustrative composition.

TABLE 2
(syrup process)

| | | | | | | HDDA | | |
|---|---|---|---|---|---|---|---|---|
| Ex. | Acrylate | | Acid | | Plasticizing Agent | (ppm) | IRG 651 | IRG 1076 |
| 9 | IOA | (50) | B-CEA | (50) | UCON 50-HB-400 (53.8) | 0 | 0.44 | 0 |
| 10 | IOA | (50) | B-CEA | (50) | UCON 50-HB-400 (53.8) | 80 | 0.44 | 0 |
| 11 | IOA | (50) | B-CEA | (50) | UCON 50-HB-400 (53.8) | 160 | 0.44 | 0 |
| C-8 | IOA | (50) | AA | (50) | UCON 50-HB-400 (53.8) | 0 | 0.44 | 0 |
| C-9 | IOA | (50) | AA | (50) | UCON 50-HB-400 (53.8) | 80 | 0.44 | 0 |
| C-10 | IOA | (50) | AA | (50) | UCON 50-HB-400 (53.8) | 160 | 0.44 | 0 |

The syrups described in Examples 9 through 11 and Comparative Examples C-8 through C-10, were coated on 0.05 mm PET to a thickness of 400 micron via the technique described in U.S. Pat. No. 4,181,752.

Both “wet” and “dry” peel adhesion, and tack, of these samples were measured as described above. The “wet” peel adhesion measurements were made by immersing a polished stainless steel panel, that had been roughened as described above, in a pan with de-ionized water. A 2.54 cm wide adhesive substrate sample was then adhered to the panel under water and rolled twice with a 2 kg hard rubber roller. The panel and adhesive substrate were then removed from the water bath and 180° peel adhesion was measured at 30.5 cm/minute rate. Time from adhering sample to panel to peel testing was approximately 30 seconds. The “dry” peel adhesion measurements were made by adhering a 2.54 cm wide adhesive substrate to a polished stainless steel panel and rolling twice with a 2 kg hard rubber roller. The 180° peel adhesion was measured at 30.5 cm/minute rate. Time from adhering sample to panel to peel testing was approximately 30 seconds. The tack test was run on a 300 mm long, 2.54 cm wide adhesive substrate sample as describe in the tack test above. Travel distance of the steel ball was recorded in mm. The results of these tests are recorded in Table 3.

TABLE 3

| | Dry Adhesion to | Wet Adhesion to | |
|---|---|---|---|
| | Stainless Steel | Stainless Steel | Tack |
| Ex. | (N/dm) | (N/dm) | (mm) |
| 1 | 49.1 | 25.9 | 3 |
| 2 | 172.7 | 27.6 | 9 |
| 3 | 205.6 | 21.8 | 3 |
| 4 | 176.0 | 59.8 | 28 |
| 5 | 142.7 | 15.5 | 25 |
| 6 | 38.3 | 23.3 | 59 |
| 7 | 42.1 | 43.5 | 5 |
| 8 | 41.8 | 40.8 | 13 |
| 9 | 35.6 | 45.2 | 1 |
| 10 | 50.1 | 46.8 | 1 |
| 11 | 97.1 | 75.4 | 1 |
| C-1 | na* | na* | na* |
| C-2 | na* | na* | na* |
| C-3 | 9.9 | 3.2 | 8 |
| C-4 | 7.3 | 0.5 | 3 |
| C-5 | na* | na* | na* |
| C-6 | 24.0 | 34.7 | 300+ |
| C-7 | na\hat{ } | na\hat{ } | na\hat{ } |
| C-8 | 70.6 | 28.2 | 300+ |
| C-9 | 94.1 | 33.9 | 300+ |
| C-10 | 70.2 | 38.0 | 300+ |

na* - samples unable to be tested due to lack of cohesive integrity
na\hat{ } - samples unable to be coated due to rigidity of adhesive in pouch

Peel adhesion to asphalt for Example 1 of the invention and Comparative Example C6 was evaluated to yield the results reported in Table 4.

TABLE 4

| | |
|---|---|
| Dry Adhesion to | Wet Adhesion to |
| asphalt (N/dm) | asphalt(N/dm) |

| Ex. | 5 min | 2 hr | 5 min | 2 hr |
|---|---|---|---|---|
| 1 | 230+ | 230+ | 20.5 | 45.5 |
| C-6 | 49.6 | 78.7 | 1.2 | 2.3 |

The data demonstrate that the use of high T_{g} monomer materials results in adhesives that have very low tack (high distance travelled via the rolling ball tack test). High tack can be important in the formation of a quick bond to surfaces. In addition the data show that the tack cannot be sufficiently raised through increasing the level of plasticizer additive when using high T_{g} monomers. The data show the surprising impact of utilizing low T_{g} monomers in formulating the adhesive. The data show that incorporation of low T_{g} monomers, such as beta-carboxyethyl acrylate, imparts high tack (low distance travelled via the rolling ball tack test) while maintaining high adhesion values both wet and dry. In addition, the data show that when using low T_{g} monomers, the adhesives surrounded by a packaging material can be polymerized without the presence of plasticizer present. This is not possible when using high T_{g} monomers, as the packaged adhesive lacking plasticizing agent becomes too rigid to extrude. The data show that the inventive adhesives exhibit similarly enhanced properties when tested for adhesion to asphalt as when tested using the more readily standardized adhesion to roughened steel test.

Various modifications and alterations of this invention will become apparent to those skilled in the art without departing from the scope and principles of this invention. It should be understood that this invention is not to be unduly limited to the illustrative embodiments set forth hereinabove and that any claimed embodiment of the invention does not necessarily include all of the features of all of the embodiments described herein. All publications and patents are incorporated herein by reference to the same extent as if each individual publication or patent was specifically and individually indicated to be incorporated by reference.

1. A pressure sensitive adhesive comprising the polymerization product of:
(a) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(b) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(c) about 10 to about 70 parts based on 100 parts (a)+(b) of a non-reactive plasticizing agent.

2. The pressure sensitive adhesive of claim 1 wherein the one or more (meth)acrylate ester monomers each has the following general formula: 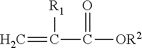
wherein R¹ is H or CH3, the latter corresponding to where the (meth)acrylate monomer is a methacrylate monomer and R² is linear or branched hydrocarbon groups and may contain one or more heteroatoms and the number of carbon atoms in the hydrocarbon group is 4 to 12.

3. The pressure sensitive adhesive of claim 2 wherein one of the one or more (meth)acrylate ester monomers is n-butyl acrylate, 2-ethylhexyl acrylate, isooctyl acrylate, or lauryl acrylate.

4. The pressure sensitive adhesive of claim 1 wherein each one of the one or more hydrophilic acidic monomers is an ethylenically unsaturated carboxylic acid, an ethylenically unsaturated sulfonic acid, or an ethylenically unsaturated phosphonic acid.

5. The pressure sensitive adhesive of claim 4 wherein at least one of the one or more hydrophilic acidic monomers is an ethylenically unsaturated carboxylic acid.

6. The pressure sensitive adhesive of claim 4 wherein at least one of the one or more hydrophilic acidic monomers is beta-carboxyethyl acrylate.

7. The pressure sensitive adhesive of claim 6 wherein there is a second hydrophilic acidic monomer.

8. The pressure sensitive adhesive of claim 7 wherein the second hydrophilic acidic monomer is acrylic acid.

9. The pressure sensitive adhesive of claim 1 wherein the plasticizing agent is selected from the group consisting of polyalkylene oxides, alkyl or aryl functionalized polyalkylene oxides, benzoyl functionalized polyethers, monomethyl ethers of polyethylene oxides and mixtures thereof.

10. A hot melt pressure sensitive adhesive comprising the pressure sensitive adhesive of claim 1, the pressure sensitive adhesive having a flow temperature and a thermoplastic packaging material enveloping said wet stick pressure sensitive adhesive, said thermoplastic packaging material having a melting temperature lower than the flow temperature of the wet stick pressure sensitive adhesive.

11. The hot melt pressure sensitive adhesive of claim 10 wherein the thermoplastic packaging material is selected from ethylene-vinyl acetate, ethylene-acrylic acid, polypropylene, polyethylene, polybutadiene, or ionomeric materials.

12. The hot melt pressure sensitive adhesive of claim 10 wherein the thermoplastic packaging material is selected from ethylene-vinyl acetate or ethylene-acrylic acid.

13. An article comprising: a substrate; and a hot melt pressure sensitive adhesive of claim 10 applied to a surface of said substrate.

14. The article of claim 13 wherein the mixture further comprises a crosslinking agent.

15. The article of claim 10 wherein the substrate and the adhesive, taken together, comprise a tape.

16. The article of claim 15 wherein the tape has a tack value, as measured by the rolling ball test, of less than 60 mm.

17. The article of claim 15 wherein the tape has a wet peel adhesion value of at least 10 N/dm.

18. The article of claim 10 wherein the plasticizing agent is selected from the group consisting of polyalkylene oxides, alkyl or aryl functionalized polyalkylene oxides, benzoyl functionalized polyethers, monomethyl ethers of polyethylene oxides and mixtures thereof.

19. A method for preparing a pressure sensitive adhesive comprising the steps of:
(a) combining a solventless polymerizable mixture comprising:
(i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.;
(ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.; and
(iii) about 10 to about 70 parts based on 100 parts of the sum of components (i)+(ii) of a non-volatile, non-reactive plasticizing agent; and
(b) polymerizing the solventless polymerizable mixture to yield the pressure sensitive adhesive.

20. A method for preparing a hot melt pressure sensitive adhesive comprising the steps of:
(a) preparing the solventless polymerizable mixture of claim 19;
(b) enveloping the polymerizable mixture in a thermoplastic packaging material; and
(c) polymerizing the solventless polymerizable mixture to yield the pressure sensitive adhesive, said pressure sensitive adhesive having a flow temperature, wherein the thermoplastic packaging material has a melting temperature lower than the flow temperature of the pressure sensitive adhesive.

21. A method for preparing a hot melt pressure sensitive adhesive comprising the steps of:
(a) preparing a prepolymeric syrup comprising:
(i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.; and
(ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.;
(b) combining the prepolymeric syrup with about 10 to about 70 parts based on 100 parts of the sum of components (i)+(ii) of a non-reactive plasticizing agent to form a polymerizable mixture;
(c) enveloping the prepolymeric syrup in a thermoplastic packaging material; and
(d) exposing the enveloped prepolymeric syrup to sufficient radiation to polymerize the prepolymeric syrup and to yield the pressure sensitive adhesive that adheres to wet substrate surfaces.

22. The method for preparing a pressure sensitive adhesive of claim 19 comprising the steps of:
(a) combining a solventless polymerizable mixture comprising:
(i) about 30 to about 70 parts by weight of one or more (meth)acrylate ester monomers wherein the (meth)acrylate ester monomers, when polymerized in the absence of other comonomers, yield a polymer or copolymer having a T_{g} of less than about 10° C.; and
(ii) about 70 to about 30 parts by weight of one or more hydrophilic acidic monomers wherein the hydrophilic acidic monomers, when polymerized in the absence of other comonomers, yield a polymer or copolymer having a T_{g} of less than about 40° C.;
(b) polymerizing the solventless polymerizable mixture; and
(c) adding about 10 to about 70 parts based on 100 parts of the sum of components (i)+(ii) of a non-volatile, non-reactive plasticizing agent, to yield the pressure sensitive adhesive.
